(19) United States
(12) Patent Application Publication
(10) Pub. No.: US 2005/0149851 A1
(43) Pub. Date: Jul. 7, 2005

(54) Generating hyperlinks and anchor text in HTML and non-HTML documents

(75) Inventor: Vibhu Mittal, Sunnyvale, CA (US)

Correspondence Address: Jung-hua Kuo;Attorney At Law, PO Box 3275, Los Altos, CA, 94024, US

(73) Assignee: Google Inc., Mountain View, CA (US)

(21) Appl. No.: 10/750,180

(22) Filed: Dec. 31, 2003

(51) Int. Cl. G06F 17/00

(52) U.S. Cl. 715/501.1; 715/513

(57) ABSTRACT

Systems and methods for generation of hyperlinks and anchor text from data such as reference text in HTML and in non-HTML documents are disclosed. The method generally includes locating a text reference in a source document, searching using a search engine for a target document relating to the text reference, computing anchor text from the text reference, generating a hyperlink to the target document, and associating the hyperlink with the computed anchor text. The locating and/or computing may be based on a respective statistical model of text formatting and/or lexical cues. The text reference may be parsed into pieces such that the searching, computing, generating, and associating are performed for each piece of text. The source document may be an HTML or non-HTML document. The text reference may be a reference to, for example, a paper, article, company, institution, product, search engine, image, object, and geographical location.

### BACKGROUND OF THE INVENTION

1. Field of the Invention

The present invention relates generally to hyperlinks and anchor text in hypertext markup language (HTML). More specifically, systems and methods for generation of hyperlinks and anchor text from data such as reference text in HTML and in non-HTML documents are disclosed.

2. Description of Related Art

One of the key useful features of HTML is that an HTML document may contain references or links to other documents or to specific sections in the same or other document. An HTML link or “hyperlink” is created by the author of a source HTML document using an HTML anchor element A to allow readers to jump to the other document or to specific sections of the same or other document in various orders based on the readers' interests. When selected by the reader, e.g., by clicking on the hyperlink with a mouse, the hyperlink causes the HTML browser to navigate to the specific section of the same or other document. When a section is not specified by the hyperlink, the hyperlink causes the HTML browser to navigate to the top of the other document. The anchor element A also allows the author to name various sections of the HTML document so that links can reference the specific sections of the HTML document. A browser typically displays a hyperlink in some distinguishing way such as in a different color, font and/or style.

Many non-HTML documents, such as scientific papers, news reports, etc., may contain linkage information embedded within the document. Sometimes such linkage information is explicit, such as when an uniform resource locator (URL) is explicitly indicated in the document but not enclosed within an HTML anchor tag. Certain applications, such as Microsoft Word and Adobe Acrobat applications, can convert the explicit linkage information to hyperlinks.

However, such linkage information may not explicit and, rather, is often implicit or indirect. In addition to non-HTML documents, many HTML documents may also contain indirect or implicit linkage information without an associated hyperlink. For example, scientific documents often cite other reference documents using the title, author, publication date, publisher, and/or various other identifying information such as the book or journal in which the reference document appears. The citations to the reference documents are typically found directly in the text of the source document, in footnotes at the bottom of each page, or in endnotes or a bibliography at the end of the document, etc. It would be desirable to generate hyperlinks with appropriate anchor text to the reference documents such that a reader may navigate directly to the reference document.

### SUMMARY OF THE INVENTION

Systems and methods for generation of hyperlinks and anchor text from data such as reference text in HTML and in non-HTML documents are disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below.

In one embodiment, a method generally includes locating a text reference in a source document, searching using a search engine for a target document relating to the text reference, computing an anchor text from the text reference corresponding to the target document, generating a hyperlink to the target document, and automatically associating the hyperlink with the computed anchor text of the text reference. The locating and/or the computing may be based on a respective statistical model of text formatting and/or lexical cues. Labels to the references in the source document may also be located and hyperlinks associated therewith. The text reference may be parsed into pieces of text such that the searching, computing, generating, and associating are performed for each piece of text. The source document may be an HTML, text, a postscript, Portable Document Format (PDF), PowerPoint, Word, or Excel document, or a close-captioned video. The text reference may be a reference to, for example, a paper, article, company, institution, product, search engine, image, object, and geographical location.

In another embodiment, a system for automatically generating hyperlinks generally includes a text reference locator to locate a text reference in a source document, a searcher to perform a search using a search engine for a target document relating to the text reference, an anchor text computing engine to compute an anchor text from the text reference corresponding to the target document, and a hyperlink generator to generate a hyperlink to the target document and to automatically associating the hyperlink with the computed anchor text of the text reference.

In yet another embodiment, a computer program product embodied on a computer-readable medium includes instructions which when executed by a computer system are operable to cause the computer system to perform the acts of locating a text reference in a source document, performing a search using a search engine for a target document relating to the text reference, computing an anchor text from the text reference corresponding to the target document, generating a hyperlink to the target document, and automatically associating the hyperlink with the computed anchor text of the text reference.

These and other features and advantages of the present invention will be presented in more detail in the following detailed description and the accompanying figures which illustrate, by way of example, the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a flowchart illustrating an exemplary process for automatically generating hyperlinks and anchor text in HTML and/or non-HTML documents.

FIG. 2 illustrates some examples of references and links to references in a source document.

FIG. 3 illustrates an example of a detailed reference in a listing of cited references, a bibliography, an endnotes section, or the like.

FIG. 4 is a block diagram of an illustrative network system.

FIG. 5 is a block diagram of an illustrative client or server device.

FIG. 6 is a block diagram illustrating a hyperlink and anchor text module in more detail.

### DESCRIPTION OF SPECIFIC EMBODIMENTS

Systems and methods for generation of hyperlinks and anchor text from data such as reference text in HTML and in non-HTML documents are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

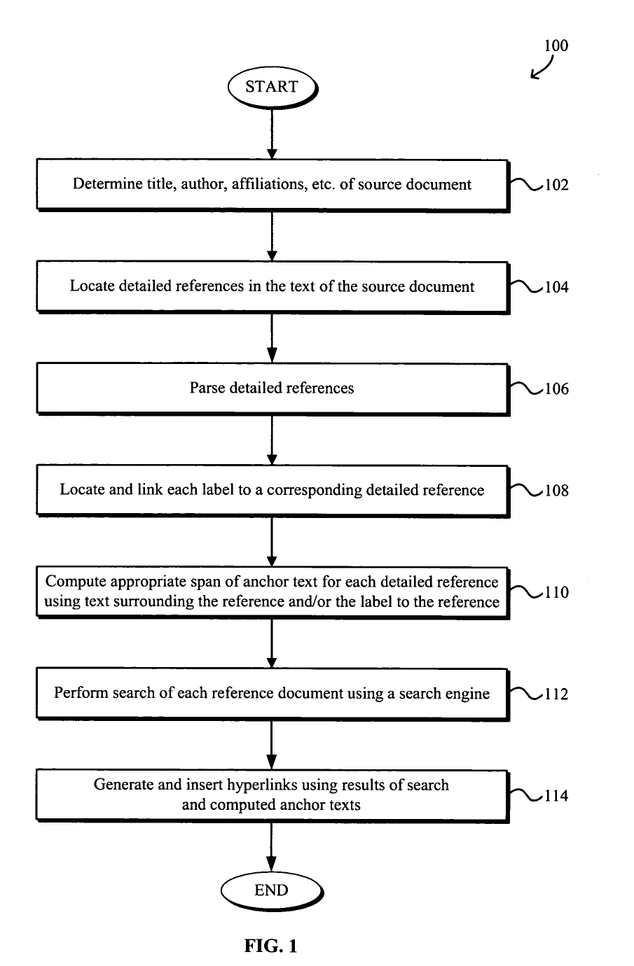

FIG. 1 is a flowchart illustrating an exemplary process 100 for automatically generating hyperlinks and anchor text in an HTML or a non-HTML source document. The automatic hyperlink and anchor text generation process 100 involves analyzing the source document for explicit and/or implicit linkage information to reference documents and automatically converting each piece of linkage information into a hyperlink and anchor text such that a reader may navigate directly to the reference document. For example, scientific documents often cite other reference documents using the title, author, publication date, and/or publisher of the referenced paper and/or various other identifying information such as the book or journal in which the reference document appears. The citations to the reference documents are typically found directly in the text of the source document, in footnotes at the bottom of each page, or in endnotes or a bibliography at the end of the document, etc.

The automatic hyperlink and anchor text generation process 100 begins at block 102 in which the source document is analyzed to extract various identifying information of the source document such as the title, author(s), affiliation(s), the publication date and/or the book or journal in which the source document appears or is published, etc. The source document can be of various suitable types of documents that may contain written text such as a text document, postscript document, a Portable Document Format (PDF) document, a PowerPoint document, a Word document, an Excel document, an HTML document, a multi-media document such as a close-captioned video, etc. The source document may be analyzed using a suitably trained statistical model of text formatting and/or lexical cues in order to extract the desired identifying information of the source document. For example, the statistical model may model the title as typically on the first page, in larger font, bold, underlined, centered, capitalized, and/or with few, if any, punctuation. As another example, the other identifying information such as author, affiliations, etc. typically follows the title and/or is at the bottom of the first page.

Next, at block 104, the detailed references are located from within the text of the source document. Similar to block 102, the detailed references may be located using a suitably trained statistical model of text formatting and/or lexical cues and/or other specific criteria for locating the references. References may include, for example, references to articles, papers, books, or the like, as well as references to companies, organizations or institutions such as universities, products, search engines, images, objects, geographical locations, etc. For example, a list of commonly referred to articles, papers, companies, institutions, products, search engines, images, and/or objects with corresponding target documents (i.e., links) may be maintained so as to simplify and expedite the process of automatically generating hyperlinks and anchor text for certain common or popular references. It is noted that for the purposes of the process 100, references need not appear in the context of the author actively referring to, i.e., “referencing,” another document. Thus, any word or combination of words may be treated as a reference and converted to a hyperlink with anchor text. It is noted that in block 104, the detailed references may be within the main body of the source document, at the bottom of each page as is the case for footnotes, and/or at the end of the document as is the case for bibliography, endnotes, list of cited references, and the like.

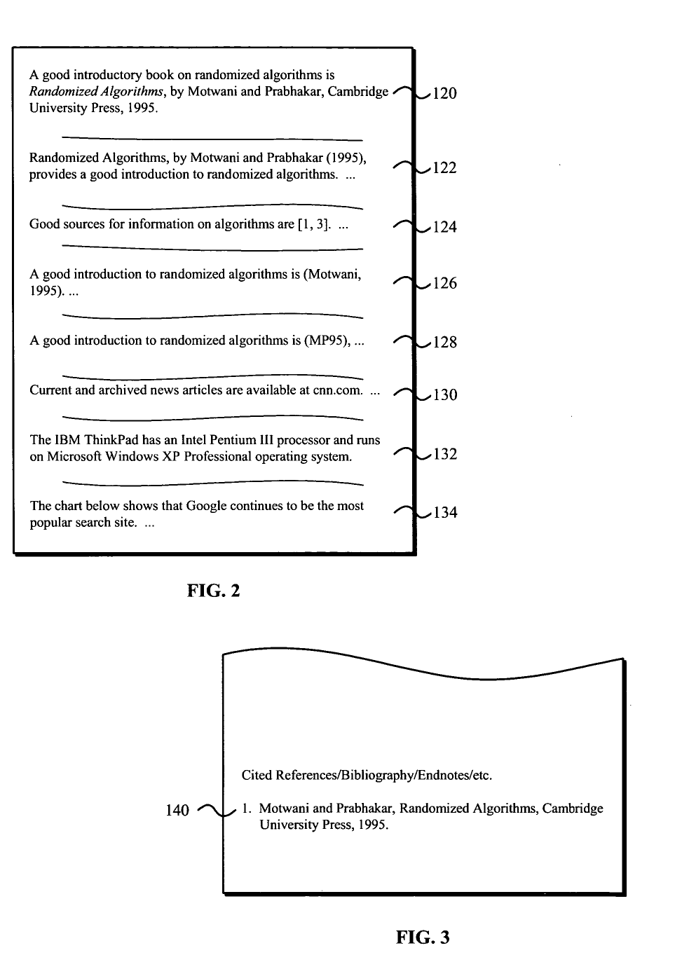

FIGS. 2 and 3 illustrate various examples of detailed references and links to detailed references in the text of the source document. As shown, the reference may be a direct reference 120 and 130 that is clearly and directly embedded in the source document. As another example, a reference 122 may alternatively be less clearly but nonetheless directly embedded in the source document.

The source document may also contain labels that serve as references to the detailed references, particularly in scientific papers or articles, where a label, e.g., footnote, endnote or a number corresponding to a listing in a bibliography, is merely a representation of the detailed reference. For example, as shown in FIG. 2, labels of various forms in references 124, 126, 128 refer to detailed references in another section of the source document, such as a detailed reference 140 in a listing of cited references, a bibliography, an endnotes section, or the like, as shown in FIG. 3. As further examples, hyperlinks and anchor texts may be generated from “IBM Thinkpad,” “Intel Pentium III Processor,” “Microsoft Windows XP Professional operating system” and Google in text 132, 134 as shown in FIG. 2. As noted above, any word or combination of words may be treated as a reference and converted to a hyperlink with anchor text.

Referring again to the process 100 shown in FIG. 1, after locating the detailed references in block 104, each detailed reference is parsed at block 106. Similar to block 102, each detailed reference can be parsed using a suitably trained statistical model of text formatting and/or lexical cues. For example, for a reference to a scientific paper, the detailed reference may be parsed into author, title, publisher, date, page numbers, volume number, etc. The statistical model for facilitating the parsing may be based on that the first letters of each word of the title and the name of the author, as well as the publisher are often capitalized and the date or year typically contains a certain number of digits and/or months spelled out. In addition, certain commonly used words such as “by,” “in,” “a,” “the,” etc. may be stripped from the detailed references in order to facilitate the search for the reference documents. For example, the detailed reference “Randomized Algorithms, by Motwani and Prabhakar, Cambridge University Press, 1995” may be parsed to obtain the title, authors, publisher, and year of publication, for example.

In one embodiment, if the source document contains labels to the detailed references, the labels are located and linked to the corresponding detailed reference at block 108. The labels may alternatively be located concurrently with the detailed references in block 104. In one embodiment, the same hyperlink may be generated for both the label and the detailed reference but each with its own corresponding anchor text. Again, the locating and linking the labels to the corresponding detailed references may be performed using a suitably trained statistical model of text formatting and/or lexical cues. For example, labels often contain numbers, single letters with or without numbers, Roman numerals, and/or portions or abbreviations (e.g., initials) of the author's name, and/or may be enclosed in brackets, braces, parenthesis, and the like.

At block 110, an appropriate span of anchor text for each detailed reference is computed using the text surrounding the detailed reference and/or the label to the reference. The text or different pieces of text surrounding the reference or the label to the reference may be used to compute an appropriate span of anchor text for the reference. In one embodiment, the algorithm to compute the appropriate span of anchor text for the reference depends on whether the label to the reference occurs at the beginning or end of a phrase. For example, if the label to the reference occurs at the beginning of a phrase, e.g., “[1,3] are good sources for information on algorithms,” an anchor text may be extracted from the text following the label until the end of the phrase, e.g., as delineated by a period, a comma, etc. In particular, the longest noun phrase, e.g., “good sources for information on algorithms,” may be extracted from the text following the label until the end of the phrase and used as the anchor text for the hyperlink. As another example, if the label to the reference occurs at the end of a phrase, e.g., “Good sources for information on algorithms are [1, 3],” an anchor text may be extracted from the text immediately preceding the label and extending until a phrase boundary is reached, e.g., as delineated by a period and/or a comma. In particular, the longest noun phrase, e.g., “Good sources for information on algorithms,” may be extracted from the text preceding the label until a phrase boundary is reached and used as the anchor text for the hyperlink. Phrase boundaries, including sentence endings, may be detected using a shallow parser, i.e., without detailed knowledge of the language in order to group words together into the appropriate anchor text, and may also be achieved using a part of speech tagger.

It is noted that a variety of suitable granularities for the anchor text may be employed. In the case of a scientific paper, for example, the entire citation of the paper may be one anchor text. Alternatively, the title of the paper may be one anchor text while the name of the author is another anchor text, the author's affiliation is yet another anchor text, and/or the journal or book in which the paper appears is yet another anchor text. In the latter case, the name of the author may serve as the anchor text for a hyperlink to the author's homepage. The author's affiliation may serve as the anchor text for a hyperlink to the company, university or other organization with which the author is affiliated. The journal or book in which the paper appears may serve as the anchor text for a hyperlink to the journal's homepage or to a web retailer from which the book may be purchased, e.g., Amazon.com. The title of the paper may serve as the anchor text for a hyperlink to the paper itself or to a specific webpage from which the paper may be requested, downloaded, or purchased, for example.

In one exemplary embodiment, after computing the anchor text for each detailed reference at block 110, a search for each reference document may be performed using a search engine at block 112. Any suitable search engine such as the Google search engine may be utilized and the search may be a search of the Internet, an intranet, a client computer system, and/or any set of documents stored on one or more computers. The process may be adaptable such that references with certain formats are searched in one database while references with certain keywords are searched in a different database, for example. In one embodiment, the search query is the anchor text as determined in block 110. The referenced or target document may be determined based on the top search result returned by the search engine. For example, the single result returned by the “I'm Feeling Lucky” search by the Google search engine may be designated as the referenced or target document. As another example, the selection of the target document may favor sponsored sites. As is evident, any other suitable method for selecting the target document from a plurality of search results may be employed.

Finally, at block 114, hyperlinks are generated and associated or inserted into the source document using the computed anchor texts as determined in block 110 and the results of the search as determined in block 112. As is evident, the automatic generation of hyperlinks and anchor text in source documents is achieved by analyzing the text of the document and reasoning using citation labels and punctuation contained in the text of the source document.

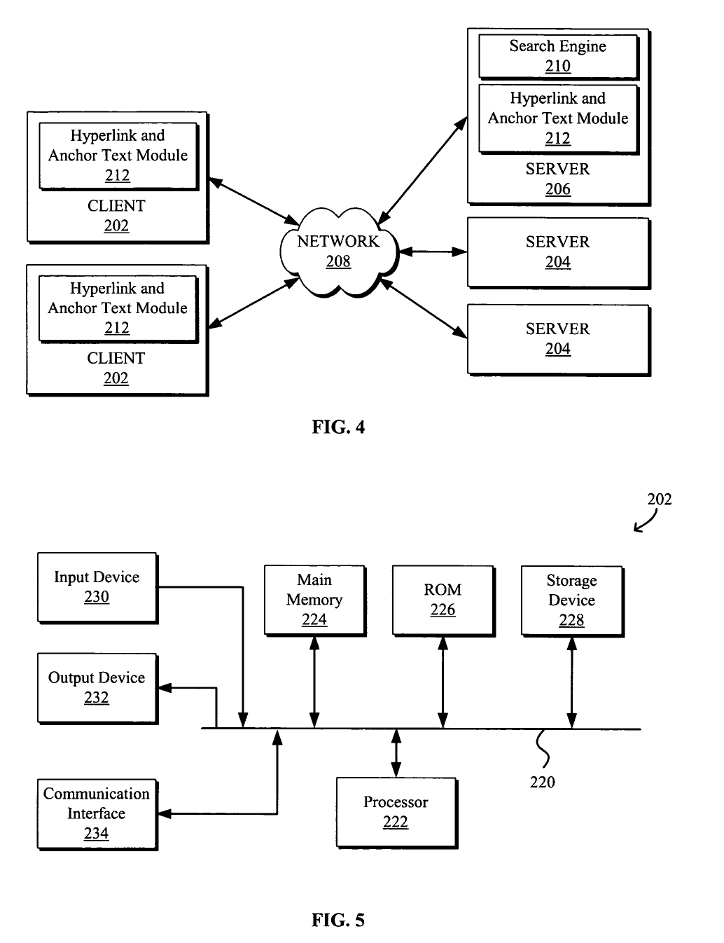

FIG. 4 illustrates an exemplary networked system 200 in which systems and methods described herein may be implemented. The networked system 200 may include client devices 202 in communication with servers 204 and 206 via a network 208. The network 208 may be a local area network (LAN), a wide area network (WAN), a telephone network, such as the Public Switched Telephone Network (PSTN), an intranet, the Internet, or any suitable combination of networks. For purposes of clarity, two client devices 202 and three servers 204 and 206 are illustrated as connected to the network 240. However, any suitable number of client devices 202 and servers 204, 206 may be connected via the network 240. In addition, a given client device may perform the functions of a server and a server may perform the functions of a client device. The client devices 202 may include devices, such as mainframes, minicomputers, personal computers, laptops, personal digital assistants, or the like, capable of connecting to the network 208. The client devices 202 may transmit data over the network 208 and/or receive data from the network 208 via a wired (e.g., copper, optical, etc.) and/or wireless connection.

The servers 204 and/or 206 may store documents (e.g., web documents) accessible by the client devices 202. In one implementation, the server 206 may include a search engine 210 usable by the client devices 202. The server 206 may additionally include a hyperlink and anchor text generator, engine or module 212. The hyperlink and anchor text module 212 enables the server to analyze and automatically generate hyperlinks in non-HTML and/or HTML documents. The hyperlink and anchor text module 212 may be implemented as part of or in addition to the search engine, for example.

Alternatively or additionally, the hyperlink and anchor text generator, engine or module 212 may be implemented on the client side via the client device 202. For example, the client side application corresponding to the source document may implement the hyperlink and anchor text module 212 via a toolbar, a dynamic link library (DLL) or any other type of plug-in, or any other suitable mechanism to implement the desired functionality in the client side application.

FIG. 5 illustrates an exemplary client device 202 suitable for implementation in the networked system 200 of FIG. 4. The client device 202 may include a bus 220, a processor 222, a main memory 224, a read only memory (ROM) 226, a storage device 228, an input device 230, an output device 232, and a communication interface 234. The bus 220 may include one or more conventional buses that permit communication among the components of the client device 202. The processor 222 may include any type of conventional processor or microprocessor that interprets and executes instructions. The main memory 224 may include a random access memory (RAM) or another type of dynamic storage device that stores information and instructions for execution by the processor 222. The ROM 226 may include a conventional ROM device or another type of static storage device that stores static information and instructions for use by the processor 222. The storage device 228 may include a magnetic and/or optical recording medium, for example, and its corresponding drive.

The input device 230 may include one or more conventional mechanisms that permit a user to input information to the client device 202 such as a keyboard, a mouse, a pen, voice recognition and/or biometric mechanisms, etc. The output device 232 may include one or more conventional mechanisms that output information to the user, including a display, a printer, a speaker, etc. The communication interface 234 may include any transceiver-like mechanism that enables the client device 202 to communicate with other devices and/or systems. For example, the communication interface 234 may include mechanisms for communicating with another device or system via a network, such as network 208.

The client devices 202 perform certain search and/or hyperlink generation operations such as those described herein. The client devices 202 may perform these operations in response to the processor 222 executing software instructions contained in a computer-readable medium, such as memory 224. A computer-readable medium may be defined as one or more memory devices and/or carrier waves. The software instructions may be read into memory 224 from another computer-readable medium such as the data storage device 228 or from another device via the communication interface 234. The software instructions contained in memory 224 causes processor 222 to perform search and/or hyperlink generation activities described herein. Alternatively, hardwired circuitry may be used in place of or in combination with software instructions to implement search and/or hyperlink generation processes described herein. Thus, the present invention is not limited to any specific combination of hardware circuitry and software.

The servers 204 and 206 may include one or more types of computer systems, such as a mainframe, minicomputer, or personal computer capable of connecting to the network 208 to enable servers 204, 206 to communicate with the client devices 202. In alternative implementations, the servers 204, 206 may include mechanisms for directly connecting to one or more client devices 202. The servers 204, 206 may transmit data over the network 208 or receive data from the network 208 via a wired or wireless connection. The servers 204, 206 may be configured in a manner similar to the client devices 202.

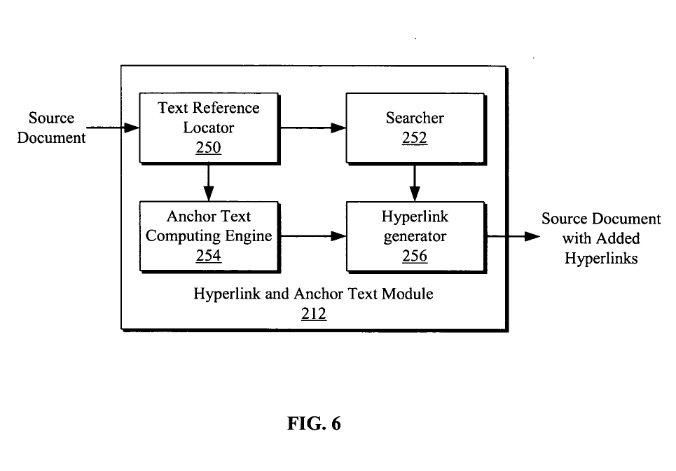

FIG. 6 is a block diagram illustrating the hyperlink and anchor text module 212 in more detail. As shown, the hyperlink and anchor text module 212 includes a text reference locator 250 configured to locate text references in a source document received as input. The text reference locator 250 outputs the located text references to a searcher 252 and an anchor text computing engine 254. The searcher 252 is configured to perform searches using a search engine for a target document relating to each located text reference while the anchor text computing engine 254 is configured to compute an anchor text from the text reference corresponding to each target document. A hyperlink generator 256 receives the outputs of both the searcher 252 and the anchor text computing engine 254, from which the hyperlink generator 256 generates a hyperlink to each target document and automatically associates each hyperlink with the computed anchor text of the corresponding text reference.

While exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A method for generating hyperlinks, comprising:
locating a text reference in a source document;
identifying a target document relating to the text reference;
deriving an anchor text corresponding to the target document utilizing the source document;
generating a hyperlink to the target document; and
associating the hyperlink with the anchor text.

2. The method of claim 1, wherein locating the text reference comprises deriving the text reference based on a statistical model of at least one of text formatting and lexical cues.

3. The method of claim 1, wherein locating the text reference comprises comparing text from the source document with a list of predetermined references.

4. The method of claim 1, further comprising:
locating a label corresponding to the text reference; and
associating the hyperlink with the label.

5. The method of claim 4, wherein the locating the label comprises deriving the label based on a statistical model of at least one of text formatting and lexical cues.

6. The method of claim 4, further comprising deriving a label anchor text depending on whether the label corresponding to the text reference precedes or follows a text phrase.

7. The method of claim 6, wherein the label anchor text is a longest noun phrase extracted from the text phrase following or preceding the label when the label precedes or follows the phrase, respectively.

8. The method of claim 1, further comprising parsing the text reference into a plurality pieces of text, wherein the identifying, deriving, generating, and automatically associating are performed for each of the plurality pieces of text.

9. The method of claim 1, wherein the source document is selected from the group consisting of an HTML document, a text document, a postscript document, a Portable Document Format (PDF) document, a PowerPoint document, a Word document, an Excel document, and a close-captioned video.

10. The method of claim 1, wherein the text reference is a reference to one of a paper, article, company, institution, product, search engine, image, object, and geographical location.

11. A system for generating hyperlinks, comprising:
a text reference locator configured to locate a text reference in a source document;
a document identifier configured to identify a target document relating to the text reference;
an anchor text determining engine configured to compute an anchor text corresponding to the target document; and
a hyperlink generator configured to generate a hyperlink to the target document and to automatically associate the hyperlink with the anchor text.

12. The system of claim 11, wherein the text reference locator is further configured to locate the text reference based on a statistical model of at least one of text formatting and lexical cues.

13. The system of claim 11, wherein the text reference locator is further configured to locate a label corresponding to the text reference and wherein the hyperlink generator is further configured to associate the hyperlink with the label.

14. The system of claim 13, wherein the text reference locator is further configured to locate the label based on a statistical model of at least one of text formatting and lexical cues.

15. The system of claim 13, wherein the anchor text determining engine is further configured to determine a label anchor text depending on whether the label corresponding to the text reference precedes or follows a text phrase.

16. The system of claim 15, wherein the label anchor text is a longest noun phrase extracted from the text phrase following or preceding the label when the label precedes or follows the phrase, respectively.

17. The system of claim 11, wherein the text reference locator is further configured to parse the text reference into a plurality pieces of text, wherein the document identifier, anchor text determining engine, and hyperlink generator are executed for each of the plurality pieces of text.

18. The system of claim 11, wherein the source document is selected from the group consisting of an HTML document, a text document, a postscript document, a Portable Document Format (PDF) document, a PowerPoint document, a Word document, an Excel document, and a close-captioned video.

19. The system of claim 11, wherein the text reference is a reference to one of a paper, article, company, institution, product, search engine, image, object, and geographical location.

20. A computer program product embodied on a computer-readable medium, the computer program product including instructions, which when executed by a computer system, are operable to cause the computer system to perform acts comprising:
locating a text reference in a source document;
identifying a target document relating to the text reference;
deriving an anchor text corresponding to the target document utilizing the source document;
generating a hyperlink to the target document; and
associating the hyperlink with the computed anchor text of the text reference.

21. The computer program product of claim 20, wherein the locating the text reference comprises computing the text reference based on a statistical model of at least one of text formatting and lexical cues.

22. The computer program product of claim 20, further including instructions operable to cause the computer system to perform acts comprising:
locating a label corresponding to the text reference; and
associating the hyperlink with the label.

23. The computer program product of claim 22, wherein the locating of the label comprises computing the label based on a statistical model of at least one of text formatting and lexical cues.

24. The computer program product of claim 22, further including instructions operable to cause the computer system to perform acts comprising:
computing a label anchor text depending on whether the label corresponding to the text reference precedes or follows a text phrase.

25. The computer program product of claim 24, wherein the label anchor text is a longest noun phrase extracted from the text phrase following or preceding the label when the label precedes or follows the phrase, respectively.

26. The computer program product of claim 20, further including instructions operable to cause the computer system to perform acts comprising parsing the text reference into a plurality pieces of text, wherein the performing the search, computing the anchor text, generating the hyperlink, and associating the hyperlink are performed for each of the plurality pieces of text.

27. The computer program product of claim 20, wherein the source document is selected from the group consisting of an HTML document, a text document, a postscript document, a Portable Document Format (PDF) document, a PowerPoint document, a Word document, an Excel document, and a close-captioned video.

28. The computer program product of claim 20, wherein the text reference is a reference to one of a paper, article, company, institution, product, search engine, image, object, and geographical location.
